(19) United States
(12) Patent Application Publication
(10) Pub. No.: US 2009/0132057 A1
(43) Pub. Date: May 21, 2009

(54) CONTROL SYSTEM FOR CONTROLLING THE MOVEMENTS OF A PLURALITY OF MECHANICAL UNITS

(75) Inventors: Tommy KETTU, Vasteras (SE); Anders Wall, Vasteras (SE); Goran Mustapic, Vasteras (SE); Peter J. Eriksson, Vasteras (SE)

Correspondence Address: BUCHANAN, INGERSOLL & ROONEY PC, POST OFFICE BOX 1404, ALEXANDRIA, VA, 22313-1404, US

(73) Assignee: ABB Research Ltd., Zurich (CH)

(21) Appl. No.: 12/267,797

(22) Filed: Nov. 10, 2008

(30) Foreign Application Priority Data
Nov. 20, 2007 (EP) 07121070.2

(51) Int. Cl. G05B 15/02; G06F 9/455; G06F 19/00

(52) U.S. Cl. 700/5; 718/1; 700/83; 700/245; 901/8; 901/7; 901/15; 901/50

(57) ABSTRACT

A control system is disclosed for controlling the movements of a plurality of mechanical units. The control system includes a plurality of independent control units, each including one or more control programs having instructions for controlling movements of at least one mechanical unit, and software for executing the control programs, wherein each control unit is configured to be put into any of a plurality of different states independent of states of remaining control units. A single server unit contains the plurality of independent control units, the server including memory for storing the control programs and the software for executing the control programs, a processor having at least one core, communication hardware for communicating with a network, and a resource-distributing unit adapted to distribute real and virtual hardware resources of the server unit to the control units, such that the control units share the real and virtual hardware resources of the server unit.

### RELATED APPLICATION

This application claims priority under 35 U.S.C. §119 to European Patent Application No. 07121070.2 filed in Europe on Nov. 20, 2007, the entire content of which is hereby incorporated by reference in its entirety.

### TECHNICAL FIELD

A control system is disclosed for controlling the movements of a plurality of mechanical units, the control system comprising a plurality of independent control units, each including one or more control programs having instructions for controlling the movements of at least one of the mechanical units and software for executing the control programs.

The mechanical units are, for example, robots, conveyers, and positioners.

### BACKGROUND INFORMATION

A known industrial robot system includes a mechanical unit and a control unit for controlling the movements of the mechanical unit. The control unit includes a program memory for storing robot programs including movement instructions for the robot, a program executer for executing the movement instructions and a path planner for planning robot paths based on the movement instructions and for generating control signals to the drive units of the robot.

In order to facilitate the automation of a complex series of actions, a plurality of robots can be placed together in a robot cell. US2004/0260426 shows a traditional robot system for controlling the movements of a plurality of robots. Each robot is provided with a control unit having hardware, such as a processor, memory, communication hardware, and hardware for handling I/O signals, and different types of software, such as control programs, and software for executing the control programs, such as an operating system. Each control unit is a physical unit separated from the other control units and can work independent of the other control units. A control unit can operate in different states such as a stopped state, a state in which the control unit automatically executes the control program, and a state in which the robot is manually controlled. The automatic state is used during normal operation of the robot, for example, when the robot performs work in a production line. The manual state is, for example, used during teaching and programming of the robot. The robot is in a stopped state when the power to the motors of the robot has been turned off, for example by activation of the emergency stop button. Each control unit can be run independent of the other control units, which means that the control units can simultaneously be in different states. For example, a first control unit can be in a stopped state at the same time as a second control unit is automatically executing a control program and a third control unit is in a manual state learning a new path.

Known industrial plants utilize systems having a single control unit and a plurality of movable mechanical units controlled by the control unit. Examples of such systems are multiple robot systems, and systems comprising one robot that cooperates with one or more external axes. A known multiple robot system includes a plurality of robots that cooperate with each other. The movements of the robots, and possible external axes, are coordinated and even synchronized with each other. In order to coordinate the movements of the mechanical units, the control unit can either execute a plurality of control programs, each control program including movement instructions for one mechanical unit, or execute one control program including movement instructions for a plurality of mechanical units. This control unit can only be in one state at a time, and can therefore not be used to independently control a plurality of robots. For example, if one robot is emergency stopped all the other robots are also emergency stopped.

From the published patent application DE10 2006 040 417A1 it is known to use a multi-core processor in a control system for controlling a machine. One of the cores is used for running real-time programs and the other core is used for running non real-time programs.

### SUMMARY

A control system is disclosed which includes a plurality of independent control units controlling a plurality of mechanical units.

In an exemplary embodiment, disclosed is a control system for controlling movements of a plurality of mechanical units the control system comprising: a plurality of independent control units, each including one or more control programs having instructions for controlling movements of at least one mechanical unit, and software for executing the control programs, wherein each control unit is configured to be put into any of a plurality of different states independent of states of remaining control units; and a single server unit containing the plurality of independent control units, the server including memory for storing said control programs and said software for executing the control programs, a processor having at least one core, communication hardware for communicating with a network, and a resource-distributing unit adapted to distribute real and virtual hardware resources of the server unit to the control units, such that the control units share the real and virtual hardware resources of the server unit.

### BRIEF DESCRIPTION OF THE DRAWINGS

Exemplary embodiments will now be explained more closely by the description of different embodiments and with reference to the appended figures.

FIG. 1 shows an example of a control system including a server unit; and

FIG. 2 shows in more detail the exemplary server unit of the control system shown in FIG. 1.

### DETAILED DESCRIPTION

In an exemplary embodiment, a control system for controlling movements of a plurality of mechanical units is disclosed. The control system includes a plurality of independent control units. The control units are arranged on a single server unit including memory for storing control programs and software for executing the control programs, a processor having at least one core, communication hardware for communicating with a network, and a resource-distributing unit adapted to distribute real and virtual hardware resources of the server unit to the control units, such that the control units share the hardware resources of the server unit. Exemplary embodiments consolidate several independent control units on one physical server unit. The control units are just as independent as if they were arranged on physically separated units. As the hardware is shared among the control units, the hardware cost of the control system is reduced. Another exemplary advantage is that the system can be space saving. The size of the new control system, including a plurality of control units, can, for example, be almost the same as known control units. Further advantages are that the control system can be more flexible and portable than known systems, allowing novel deployment scenarios.

A plurality of independent control units can be used, each controlling different mechanical units can be used, on one physical server unit. For example, one of the control units can be in a state in which the mechanical unit is manually operated, and the other control units can be in a state in which the control units automatically execute the control programs.

According to an exemplary embodiment, the processor can be a multi core processor and the resource-distributing unit can be configured to assign at least one core to each control unit. The recourse-distributing unit can comprise a scheduler. This embodiment makes it possible to distribute at least one core to each control unit. Since each control unit is run on its own processor core, the scheduler can be made relatively simple.

According to an exemplary embodiment, at least two control units share a core of the processor, and the resource-distributing unit can be configured to distribute the time for utilizing the core between the control units.

According to an exemplary embodiment, each control unit comprises a real-time operating system, or at least a sub-set of a real-time operating system, and the resource-distributing unit is configured to simultaneously run the operating systems of the control units while ensuring real-time behavior of the real-time operating systems. In many applications, such as controlling robots, there can be a demand for processing signals in real-time. Therefore exemplary embodiments can ensure a real-time behavior of the operating systems of the control units, even though the operating systems are run simultaneously.

According to an exemplary embodiment, the resource-distributing unit is a real-time hypervisor. Hypervisors are also called virtual machine managers. Real-time hypervisors allow multiple real-time operating systems to share the resources of a single hardware platform and ensure real-time behavior of the real-time operating systems.

According to an exemplary embodiment, the control system can comprise at least one Human Machine Interaction (HMI) unit comprising communication hardware for communicating with the control units via the network. Thus, the server unit does not have to be provided with any man-machine interface. This embodiment also enables the use of a shared man-machine interface for the control units. The shared man-machine interface communicates with the control units via a network, which can, for example, be wireless. A shared man-machine interface can further reduce hardware costs of the control system. Further, each control unit can be adapted to communicate with one or more of the mechanical units via the network. This embodiment makes it possible to locate the control units at a distance from the robot cell, for example, in a server room with suitable climate, such as suitable temperature and humidity, for the server hardware.

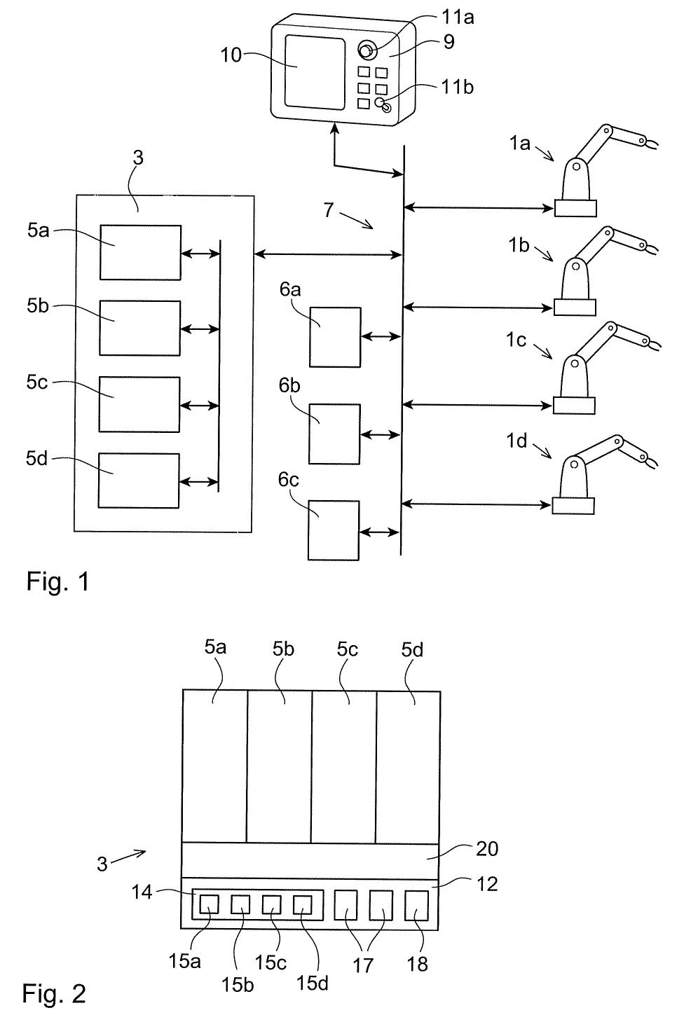

FIG. 1 shows an example of an exemplary control system for controlling the movements of a plurality of mechanical units 1a-d. In the following example the mechanical units are robots; however the mechanical units can be other types of movable mechanical units, such as external axes, positioners and conveyers. The control system includes a server unit 3 comprising a plurality of independent control units 5a-d. The server unit 3 is a single physical unit and includes memory for storing control programs for controlling the movements of the mechanical units and for storing software for executing the control programs, such as operating systems.

Each control unit 5a-d is adapted to control the movement of at least one mechanical unit. In this example, each control unit controls the movement of one mechanical unit. The control units 5a-d comprise software, such as robot programs including a series of robot program instructions written in a robot language, and software, often called a program executer, for executing the robot program instructions. The robot program instructions include movement instructions for the mechanical unit. Each control unit can further comprise software, often called a path planner, configured to receive instructions from the program executor and on basis thereof determine how the mechanical unit should move in order to be able to execute the movement instruction. The path planner can plan how the instructed movement should be performed by carrying out an interpolation of the movement. For example, the path planner computes position references for the axes of the robot. The position references are then converted into motor references. The path planner transmits the computed motor references to drive units of the robot. The drive unit controls the motors of the mechanical unit by controlling the motor torque and the motor position in response to reference values from the control unit. In this example, the drive units of the robot are located in the mechanical units 1a-d.

The control system can further comprise a communication network 7. The network is adapted for communication in a specific working area and may be a wired network, a wireless network, or a combination of both. The network solution is, for example, LAN, WLAN, an Ethernet communication type or the like. The server unit 3 is a physical node in a network 7. Each robot 1a-d is also a physical node in the network 7. The control units 5a-d are internal nodes in the server unit 3 and communicate with other components connected to the network 7, such as the robots 1a-d, via the server node.

The control system can further comprise a HMI (Human Machine Interaction) device 9. The HMI device 9 is, for example, equipped with a display 10 and safety equipment, such as an emergency stop button or a stop button 11a. The exemplary HMI device 9 is also provided with switches and/or buttons for interaction with the control units, for example, a mode-switching button 11b for switching between manual and automatic mode. The HMI device 9 is further provided with communication hardware, such as a network adapter, for sending and receiving messages via the network 7. The HMI device is a physical node in the network 7. The HMI device 9 is configured to communicate with any of the control units 5a-d via the network 7. The operator selects which one of the control units the HMI device shall communicate with at the moment. Thus, the control units share the HMI device. For example, all human interactions with the control units are made through the HMI device. The server unit 3, the HMI device 9, and the mechanical units 1a-d including the drive units are all physical nodes in the network 7. It is also possible to have new types of man machine interfaces such as Personal Digital Assistants (PDAs), mobile telephones, and heads up displays. These devices can, for example, communicate with the server unit 3 over a wireless network.

The control system can further comprise a plurality of safety units 6a-b connected to the network 7. The safety units are, for example emergency stop units, gates and photo-electric trip devices. Further, process control units 6c, such as welding equipment, process I/O units, and sensor units, for example a camera, can be connected to the network 7.

FIG. 2 shows the server unit 3 including the control units 5a-d in more detail. Each of the control units 5a-d comprises software for controlling at least one of the mechanical units. The software includes control programs, software for executing the control programs, software for path planning, software for computing reference positions for the drive units, and a real-time operating system, or at least vital parts of a real-time operating system. The server unit 3 includes hardware resources 12 that are shared among the control units 5a-d. The hardware resources 12 include a processor 14 containing one or more cores. In order to assure real-time behavior of the control units, it is suitable to assign at least one core to each control unit 5a-d. However, new technology also makes it possible for two or more control units to share one core.

In the FIG. 2 embodiment the processor 14 has four cores 15a-d corresponding to the number of control units 5a-d. However, the number of cores may vary depending on the application. Further, the hardware resources 12 include memory 17 for storing control programs, for storing software for executing the control programs and for path planning, as well as other types of memory necessary for the control units to be able to control the mechanical units. The server unit can include nonvolatile memory as well as other types of memory, such as RAM and ROM. The hardware resources 12 can also include communication hardware, such as network adapters 18 and hardware for handling I/O signals. In order to ensure real-time behavior, each control unit can be assigned one network adapter of its own. The hardware resources 12 may also include other types of hardware needed by the control units.

The server unit 3 can further include a resource-distributing unit 20 adapted to distribute the hardware resources 12, as well as virtual hardware resources to the control units 5a-d, such that the control units share the hardware resources of the serving unit. The resource-distributing unit is, for example, a real-time hypervisor. Hypervisors, also called virtual machine managers, supporting virtualization of non real-time operating systems have existed for many years. Hypervisors supporting real-time operating systems are however relatively new. Real-time hypervisors are, for example, supplied by TenAsys and VirtualLogix. This technology is described in an article written by Paul Fischer in Development Tool & RTOS, page 33-34, October 2006, “About hardware virtualization features and real-time hypervisor software”, the disclosure of which is hereby incorporated by reference in its entirety. The real-time virtualization technology enables multiple operating systems to run simultaneously on the same processor. The operating systems are run independent from each other. An abstraction layer, named virtualizer, manages the hardware resources and isolates the operating systems from the underlying hardware. The virtualization technology relies primarily on partitioning of resources between the operating systems and on virtualization of resources, which cannot be partitioned.

Some of the hardware resources, such as the physical memory and the communication hardware are partitioned between the control units, while the CPU and other system parts, such as the real-time clock and interrupt controllers are virtualized by the virtualization software. I/O devices which will be used by a single control unit are assigned to that control unit. Resources that are common to more than one of the control units, such as the CPU and real-time clock are virtualized so that they can be shared between those control units that need to access such a resource. A CPU is for example shared by means of a scheduler, which assigns a processor to the selected control unit.

Each of the control units 5a-d comprises software for controlling at least one of the mechanical units. The software includes control programs, software for executing the control programs, software for path planning, software for computing reference positions for the drive units, and an operating system, or at least vital parts of a real-time operating system. In order to assure a real-time behavior of the control units, it is suitable to assign at least one processor core to each control unit. However, existing technology also makes it possible for two or more control units to share one processor core.

The control units 5a-b can work totally independent of each other. Each control unit can be configured to be put into a plurality of different states, such as a state in which the control unit is stopped, and a state in which the control unit automatically executes the control program, independent of the state of the other control units. Thus, one of the control units can be stopped at the same time as the other control units are running. The only thing the control units have in common is that they share the same hardware.

The present disclosure is not limited to the embodiments disclosed but may be varied and modified within the scope of the following claims. For example, the server unit 3 may comprise other types of software, such as software for process control, for line control, for sensor processing, and for cell control, or for any other desired control.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A control system for controlling movements of a plurality of mechanical units, the control system comprising:
a plurality of independent control units, each including one or more control programs having instructions for controlling movements of at least one mechanical unit, and software for executing the control programs, wherein each control unit is configured to be put into any of a plurality of different states independent of states of remaining control units; and
a single server unit containing the plurality of independent control units, the server including memory for storing said control programs and said software for executing the control programs, a processor having at least one core, communication hardware for communicating with a network, and a resource-distributing unit adapted to distribute real and virtual hardware resources of the server unit to the control units, such that the control units share the real and virtual hardware resources of the server unit.

2. The control system according to claim 1, wherein said processor is a multi-core processor and the resource-distributing unit is configured to assign at least one core to each control unit.

3. The control system according to claim 1, wherein at least two control units share a core of the processor, and the resource-distributing unit is configured to distribute time for utilizing the core between the at least two control units.

4. The control system according to claim 1, wherein each control unit comprises:
at least a sub-set of a real-time operating system, said resource-distributing unit being configured to simultaneously run the real-time operating systems of the control units while supervising real-time behavior of the real-time operating systems.

5. The control system according to claim 1, wherein said resource-distributing unit is a real-time hypervisor.

6. The control system according to claim 1, comprising:
at least one Human Machine Interaction unit having communication hardware for communicating with said control units via said network.

7. The control system according to claim 1, wherein the server unit is a physical node and each control unit is a logical node in said network.

8. The control system according to claim 1, wherein said states include a state in which the control unit automatically executes the control program and a state in which the mechanical unit is manually operated.

9. The control system according to claim 1, wherein each control unit is adapted to communicate with one or more of the mechanical units via said network.

10. The control system according to claim 1, in combination with a plurality of industrial robots, wherein the plurality of robots are controlled by the control system.

11. The control system according to claim 2, wherein at least two control units share a core of the processor, and the resource-distributing unit is configured to distribute time for utilizing the core between the two control units.

12. The control system according to claim 11, wherein each control unit comprises:
at least a sub-set of a real-time operating system, said resource-distributing unit being configured to simultaneously run the real-time operating systems of the control units while supervising real-time behavior of the real-time operating systems.

13. The control system according to claim 11, wherein said resource-distributing unit is a real-time hypervisor.

14. The control system according to claim 13, comprising:
at least one Human Machine Interaction unit having communication hardware for communicating with said control units via said network.

15. The control system according to claim 11, wherein the server unit is a physical node and each control unit is a logical node in said network.

16. The control system according to claim 11, wherein said states include a state in which the control unit automatically executes the control program and a state in which the mechanical unit is manually operated.

17. The control system according to claim 11, wherein each control unit is adapted to communicate with one or more of the mechanical units via said network.
